(19) United States
(12) Patent Application Publication
(10) Pub. No.: US 2026/0318406 A1
(43) Pub. Date: Oct. 15, 2026

(54) CONTROLLING GEAR SHIFTS

(71) Applicant: JAGUAR LAND ROVER LIMITED, Warwickshire (GB)

(72) Inventors: Tom OWEN, Whitley, Coventry, Warwickshire (GB); Sam JOHNSON, Whitley, Coventry, Warwickshire (GB); Robert CREAN, Whitley, Coventry, Warwickshire (GB); James MANNION, Whitley, Coventry, Warwickshire (GB); James CANNON, Whitley, Coventry, Warwickshire (GB)

(21) Appl. No.: 19/482,883

(22) PCT Filed: May 7, 2024
(86) PCT No.: PCT/EP2024/062635

§ 371 Date: Nov. 10, 2025

(30) Foreign Application Priority Data
May 11, 2023 (GB) 2306972.7

(51) Int. Cl. F16H 61/16; F16H 59/14; F16H 59/18; F16H 59/36; F16H 59/40; F16H 59/42; F16H 59/44; F16H 59/70; F16H 61/04

(52) U.S. Cl. CPC F16H 61/16; F16H 59/18; F16H 59/40; F16H 59/42; F16H 59/44; F16H 59/70; F16H 61/0437; F16H 2059/147; F16H 2059/183; F16H 2059/366; F16H 2061/0459; F16H 2061/161; F16H 2061/163

(57) ABSTRACT

Aspects and embodiments of the invention relate to a control system (100), an automatic transmission system (10), a vehicle (1), a method (300′), and computer readable instructions, for controlling an automatic transmission (12) of a vehicle (1), comprising: receiving (302) a signal indicative of a speed parameter; receiving (304) a signal indicative of an accelerator input; determining (306) a target gear ratio based on the speed parameter and the accelerator input; inhibiting (338) output of a signal comprising instructions to cause initiation of a shift to the target gear ratio for an initial period of time in dependence on a shift inhibit condition being satisfied; after the initial period of time, inhibiting (344) output of a signal comprising instructions to cause initiation of a shift to the target gear ratio until it is determined that an instantaneously initiated shift will not complete during lash crossing.

### TECHNICAL FIELD

The present disclosure relates to controlling gear shifts. Aspects of the invention relate to a control system, to an automatic transmission system, to a vehicle, to a method, and to computer readable instructions.

### BACKGROUND

It is known to provide automatic transmissions in vehicles. Automatic transmissions do not require input from a driver to shift gears. Gear management is instead provided to determine when it is appropriate to shift gear and what gear is appropriate to adopt in a given set of circumstances.

Some sets of circumstances are relatively stable, while others may be highly transient. When the set of circumstances is highly transient, the determined gear shifts and timing may rapidly become inappropriate. Accordingly, effective gear management is challenging.

### SUMMARY OF THE INVENTION

Aspects and embodiments of the invention provide a control system, an automatic transmission system, a vehicle, a method, and computer readable instructions as claimed in the appended claims.

According to an aspect of the present invention there is provided a control system for an automatic transmission of a vehicle comprising any one or more of the features described herein.

According to an aspect of the present invention there is provided a control system for an automatic transmission of a vehicle. The control system comprises one or more controllers. The control system configured to:
receive a signal indicative of a speed parameter;
receive a signal indicative of an accelerator input;
determine a target gear ratio based on the speed parameter and the accelerator input;
inhibit output of a signal comprising instructions to cause initiation of a shift to the target gear ratio for an initial period of time in dependence on a shift inhibit condition being satisfied;
after the initial period of time, inhibit output of a signal comprising instructions to cause initiation of a shift to the target gear ratio until it is determined that an instantaneously initiated shift will not complete during lash crossing.

An advantage of this is that poor quality shifts, which may involve particularly perceptible backlash, can be avoided. If a gear shift in proposed, it may be that the current gear ratio may not be suitable for maintaining powertrain torque in the current situation. In the event that this gear shift is inhibited, this may lead to torque which is falling towards the lash region. Extending the duration of the inhibit so that any subsequent shift will complete after the lash region has been crossed therefore avoids such shifts being of poor quality.

Optionally the control system is configured to: receive a signal indicative of a powertrain torque; receive a signal indicative of a current gear ratio; and determine if an instantaneously initiated shift will complete during lash crossing in dependence on an instantaneous value of the powertrain torque, the accelerator input, and the current gear ratio.

Optionally determining if an instantaneously initiated shift will complete during lash crossing comprises: looking-up, using the accelerator input and the current gear ratio, a predetermined range of powertrain torque values, wherein the predetermined range of powertrain torque values comprise values which, provided a powertrain torque decline follows a trajectory expected at the accelerator input and the current gear ratio, will decline to values within a lash region over a duration of a shift; and determining if the instantaneous value of the powertrain torque is within the predetermined range of powertrain torque values.

Optionally there is a maximum duration of inhibiting output of a signal comprising instructions to cause initiation of a shift to the target gear ratio.

Optionally the shift inhibit condition comprises at least one of the following:
a rate of decrease in the accelerator input exceeding a threshold rate;
a propulsion system of the vehicle being in transition between predefined operating modes;
a different target gear ratio being determined based on a change to at least one of: the speed parameter, the accelerator input, or an active shift map;
a rate of decrease in a powertrain torque exceeding another threshold rate.

Optionally the initial period of time is based on the shift inhibit condition which has been satisfied.

Optionally the speed parameter is a speed parameter of the vehicle or of a powertrain component.

Optionally the speed parameter is one of the following: a vehicle speed, a wheel speed, a transmission output shaft speed, a transmission input shaft speed, or an engine and/or electric machine speed.

According to a further aspect of the present invention there is provided a control system for an automatic transmission of a vehicle. The control system comprises one or more controllers. The control system configured to:
receive a signal indicative of a speed parameter;
receive a signal indicative of an accelerator input;
determine a target gear ratio based on the speed parameter and the accelerator input;
output a signal comprising instructions to cause initiation of a shift to the target gear ratio in dependence on a shift inhibit condition not being satisfied;
output a signal comprising instructions to cause cancellation of the shift to the target gear ratio in dependence on the shift inhibit condition being satisfied during a period between outputting the signal comprising instructions to cause initiation of the shift and a completion of the shift;
after the output of the signal comprising instructions to cause cancellation of the shift to the target gear ratio, inhibit output of a further signal comprising instructions to cause initiation of a shift to the target gear ratio until it is determined that an instantaneously initiated shift will not complete during lash crossing.

Optionally the control system is configured to inhibit output of a further signal comprising instructions to cause initiation of a shift to the target gear ratio for an initial period of time before determining if an instantaneously initiated shift will complete during lash.

Optionally the initial period of time is based on the shift inhibit condition which has been satisfied.

According to a further aspect of the invention, there is provided an automatic transmission system comprising the control system.

According to a further aspect of the invention, there is provided a vehicle comprising the automatic transmission system.

According to a further aspect of the invention, there is provided a method of controlling an automatic transmission of a vehicle, the method comprising:
receiving a signal indicative of a speed parameter;
receiving a signal indicative of an accelerator input;
determining a target gear ratio based on the speed parameter and the accelerator input;
inhibiting output of a signal comprising instructions to cause initiation of a shift to the target gear ratio for an initial period of time in dependence on a shift inhibit condition being satisfied;
after the initial period of time, inhibiting output of a signal comprising instructions to cause initiation of a shift to the target gear ratio until it is determined that an instantaneously initiated shift will not complete during lash crossing.

According to a further aspect of the invention there is provided computer readable instructions which, when executed by a computer, are arranged to perform any one or more of the methods described herein. According to a further aspect of the invention there is provided a non-transitory computer readable medium comprising computer readable instructions that, when executed by one or more electronic processors, causes the one or more electronic processors to carry out any one or more of the methods described herein.

Within the scope of this application, it is expressly intended that the various aspects, embodiments, examples and alternatives set out in the preceding paragraphs, in the claims and/or in the following description and drawings, and in particular the individual features thereof, may be taken independently or in any combination that falls within the scope of the appended claims. That is, all embodiments and/or features of any embodiment can be combined in any way and/or combination that falls within the scope of the appended claims, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 illustrates an example of a vehicle;

FIG. 2 illustrates an example of at least part of a powertrain of a vehicle;

FIG. 3 illustrates an example of a control system;

FIG. 4 illustrates an example of a non-transitory computer-readable storage medium;

FIG. 5 illustrates an example of a method;

FIG. 6 illustrates a further example of the method;

FIG. 7 illustrates a further example of the method;

FIG. 8 illustrates a further example of the method;

FIG. 9 illustrates a further example of the method;

FIG. 10A to E illustrate a further example of the method

FIG. 11 illustrates a further example of the method;

FIG. 12 illustrates a further example of the method;

FIG. 13 illustrates an example of a further method;

FIG. 14A to C illustrate an example of a result of the further method;

FIG. 15 illustrates a further example of the further method; and

FIG. 16 illustrates an example of a combination of the method and further method.

### DETAILED DESCRIPTION

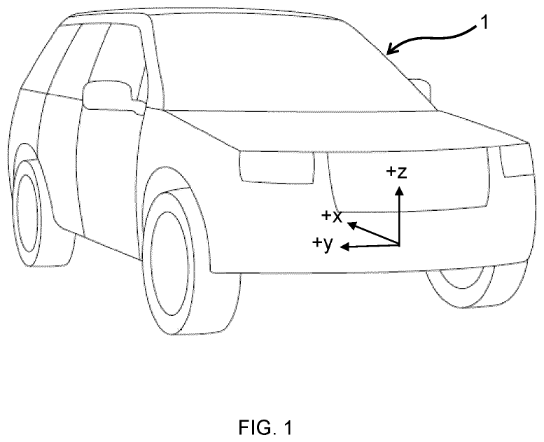

A vehicle 1 in accordance with an embodiment of the present invention is described herein with reference to the accompanying FIG. 1. In some, but not necessarily all examples, the vehicle 1 is a passenger vehicle, also referred to as a passenger car or as an automobile. In other examples, embodiments of the invention can be implemented for other applications, such as commercial vehicles.

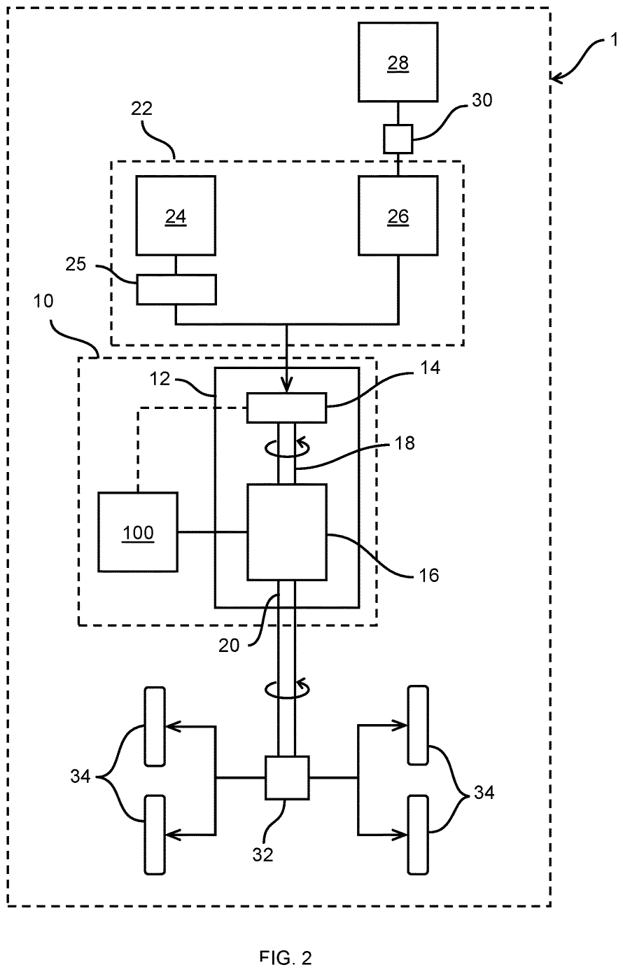

FIG. 2 schematically illustrates an example of at least part of a powertrain of the vehicle 1.

In this example, the vehicle 1 comprises a propulsion system 22 comprising a plurality of torque sources 24, 26 which are selectively operable for the purpose of providing drive torque for accelerating the vehicle 1.

A torque source refers to a prime mover, such as an internal combustion engine, an electric machine such as a traction motor, or the like.

In the illustrated example, the propulsion system 22 comprises two torque sources 24, 26. A first torque source 24 is an internal combustion engine (‘engine’). A second torque source 26 is an electric machine.

The electric machine 26 is an electric motor arranged to convert electrical energy into kinetic energy in the form of mechanical torque and vice versa. The electric motor 26 may be an alternating current induction motor or a permanent magnet motor, or another type of motor. The electric machine 26 is a traction motor configured to enable at least an electric mode comprising electric-only driving. That is, the electric machine 26 can drive the vehicle by itself (without an engine).

This propulsion system 22 is configured to operate in a plurality of predefined operating modes. These include at least an electric mode and a parallel hybrid mode.

In the electric mode (also known as electric vehicle (EV) mode or electric-only mode) the vehicle 1 is propelled only by torque generated by the electric machine 26. The engine 24 may be off (in a non-running state) such that fuel is not combusted, though it may still be rotating if not disconnected from the wheels 34. The engine 24 may alternatively be on but only for the purpose of generating electrical energy and not connected to a torque path to the wheels 34.

In the parallel hybrid mode the vehicle 1 is propelled by torque generated by both the engine 24 and by the electric machine 26.

The predefined operating modes may also include an engine-only mode in which the vehicle 1 is propelled only by torque generated by the engine 24 and there is no electric propulsion.

Transitioning between predefined operating modes of the propulsion system 22 comprises turning on or off one of the torque sources 24, 26 so that, respectively, it either does or does not output torque. In some examples, transitioning between predefined operating modes further comprises mechanically connecting (coupling) or disconnecting (uncoupling) one of the torque sources 24, 26 to the drivetrain. A coupling clutch 25 is provided to mechanically connect and disconnect the engine 24 from the drivetrain. It will be appreciated that the transition between the predefined operating modes is not instantaneous. While the propulsion system 22 is transitioning between predefined operating modes, its mode status is ‘in transition’.

The vehicle 1 comprises an automatic transmission system 10 comprising an automatic transmission 12 and a control system 100 such as a transmission control unit/module for controlling the automatic transmission 12.

The automatic transmission 12 comprises a launch device 14 which transfers torque output by the operating torque sources 24, 26 of the propulsion system 22 to the transmission input shaft 18. The launch device 14 may be a fluid coupling such as a torque converter or one or more automatically-actuated friction clutches as found in, for example, a dual-clutch transmission.

The automatic transmission 12 also comprises a gear set and accompanying shifting mechanism, referenced in combination as 16. The gear set 16 comprises a plurality of gears which are selectively couplable into different gear trains to enable multiple gear ratios between the transmission input shaft 18 and the transmission output shaft 20. Each gear may have a corresponding clutch configured to couple them (directly or indirectly) to the transmission output shaft 20.

The clutches and their actuators form the shifting mechanism. The actuators may be solenoids.

The shifting mechanism is controlled to establish a selected gear ratio in accordance with a control signal output by the control system 100. The control system 100 may determine which clutches are involved in shifting to the selected gear ratio and determine how the pressure at the clutches should be controlled to establish the selected gear ratio. The control system 100 may then directly control the actuators associated with these clutches to increase or decrease pressure at these clutches as required. The shifting mechanism may shift up, that is to a higher gear ration, or shift down, that is to a lower gear ratio, as required, determined or requested.

The control system 100 is also capable of controlling actuation of the launch device 14.

The transmission output shaft 20 is connected to a final set of gears 32, such as a pinion gear meshed with a ring gear, to transfer torque to the wheel axles and thus the vehicle wheels 34.

In order to store electrical energy for the electric machine 26, the vehicle 1 comprises an electrical energy storage means 28. The electrical energy storage means 28 can be a traction battery. The traction battery 28 provides a nominal voltage required by electrical power users such as the electric machine 26.

The traction battery 28 may be a high voltage battery. The traction battery 28 may have a voltage and capacity to support electric only driving for sustained distances. The traction battery 28 may have a capacity of several kilowatt-hours, to maximise range. The capacity may be in the tens of kilowatt-hours, or over a hundred kilowatt-hours.

Although the traction battery 28 is illustrated as one entity, the function of the traction battery 28 could be implemented using a plurality of small traction batteries in different locations on the vehicle 1.

An inverter 30 converts between the DC output of the traction battery 28 and the AC input required for the electric machine 26.

In view of the above description of the vehicle 1, it will be understood that the vehicle 1 is a full hybrid electric vehicle (HEV). However, in some examples the vehicle 1 may be other than as shown in FIG. 2. The vehicle 1 may be a mild HEV, an internal combustion engine vehicle (ICEV) or otherwise.

Mild HEVs do not have an electric-only mode of propulsion, but the electric machine 26 may be configured to provide assistance such as boosting output torque of the engine 24. The electric machine 26 is not configured to drive the vehicle 1 under electric power alone.

ICEV are propelled solely by an engine 24. Any on-board electric machine is used only as a starter-generator.

At least some of the disclosures made herein can find application in any of these vehicles.

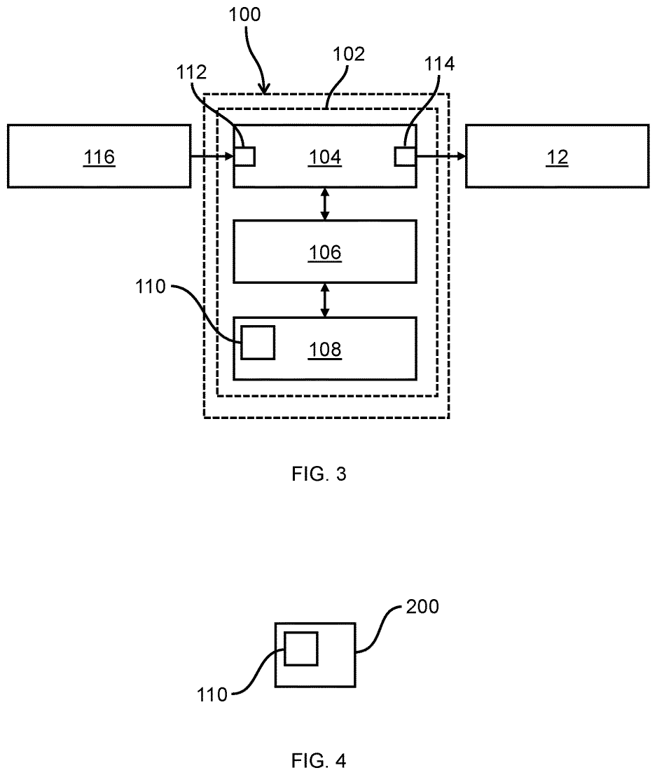

FIG. 3 illustrates an example of the control system 100 for the automatic transmission 12 of the vehicle 1. The control system 100 comprises one or more controllers 102.

The control system 100 is configured to receive data from multiple sensors 116. The control system 100 is configured to receive accelerator input data from, for example, an accelerator pedal sensor or a system processing the output of the accelerator pedal sensor to determine a torque to request of the propulsion system 22 or from an automated driving system (ADS) or an advanced driver-assistance system (ADAS). The control system 100 is configured to receive speed parameter data from, for example, a crank position sensor, a drivetrain speed sensor, a wheel speed sensor measure, or the like. The control system 100 is configured to determine a target gear ratio based on the accelerator input data and the speed parameter data. The control system 100 is also configured to receive data about, for example, a rate of change of accelerator input, a status of the propulsion system 22, a powertrain torque, or the like, and to determine whether to permit, inhibit, or cancel a gear shift in dependence on this received data. The control system 100 may then output a control signal comprising instructions to cause initiation or cancellation of a shift (by for example controlling the automatic transmission 12, and specifically the shifting mechanism which functions to establish a gear ratio).

The control system 100 as illustrated in FIG. 3 comprises one controller 102, although it will be appreciated that this is merely illustrative. The controller 102 comprises processing means 106 and memory means 108. The processing means 106 may be one or more electronic processing devices 106 which operably execute computer-readable instructions. The memory means 108 may be one or more memory devices 108. The memory means 108 is electrically coupled to the processing means 106. The memory means 108 is configured to store instructions, and the processing means 106 is configured to access the memory means 108 and execute the instructions stored thereon.

The controller 102 comprises an input means 112 and an output means 114. The input means 112 may comprise an electrical input 112 of the controller 102. The output means 114 may comprise an electrical output 114 of the controller 102. The controller 102 may have an interface 104 comprising an electrical input/output I/O 112, 114, or an electrical input 112, or an electrical output 114, for receiving information and interacting with external components. The input 112 is arranged to receive a plurality of signal from a plurality of sensors 116. At least one signal is an electrical signal which is indicative of an accelerator input. At least one other signal is an electrical signal which is indicative of a speed parameter. The output 114 is arranged to output control signals comprising instructions to cause initiation of or cancellation of a gear shift.

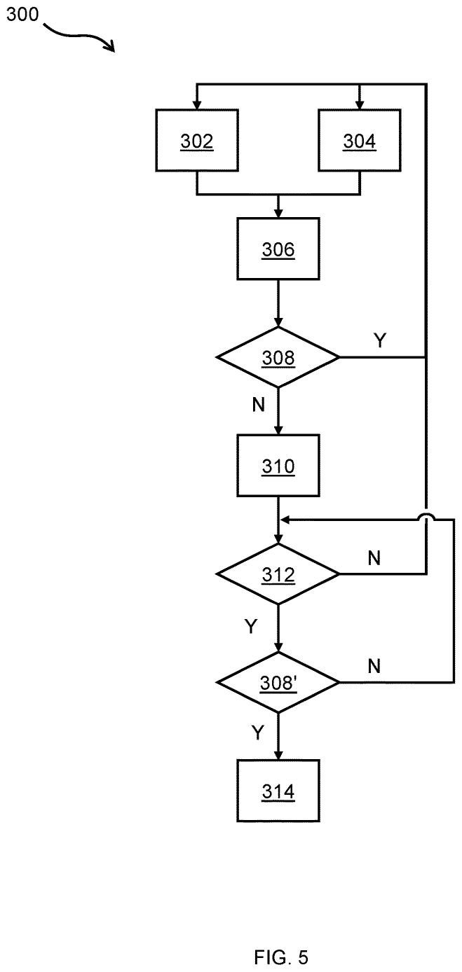

FIG. 4 illustrates a non-transitory computer-readable storage medium 200 comprising the instructions (computer software).

It is to be understood that the or each controller 102 can comprise a control unit or computational device having one or more electronic processors (e.g., a microprocessor, a microcontroller, an application specific integrated circuit (ASIC), etc.), and may comprise a single control unit or computational device, or alternatively different functions of the or each controller 102 may be embodied in, or hosted in, different control units or computational devices. As used herein, the term “controller,” “control unit,” or “computational device” will be understood to include a single controller, control unit, or computational device, and a plurality of controllers, control units, or computational devices collectively operating to provide the required control functionality. A set of instructions could be provided which, when executed, cause the controller 102 to implement the control techniques described herein (including some or all of the functionality required for the method(s) described herein). The set of instructions 110 could be embedded in said one or more electronic processors 106 of the controller 102; or alternatively, the set of instructions 110 could be provided as software to be executed in the controller 102. A first controller or control unit may be implemented in software run on one or more processors. One or more other controllers or control units may be implemented in software run on one or more processors, optionally the same one or more processors as the first controller or control unit. Other arrangements are also useful.

The, or each, electronic processor 106 may comprise any suitable electronic processor (e.g., a microprocessor, a microcontroller, an ASIC, etc.) that is configured to execute electronic instructions 110. The, or each, electronic memory device 108 may comprise any suitable memory device and may store a variety of data, information, threshold value(s), lookup tables or other data structures, and/or instructions therein or thereon. In an embodiment, the memory device 108 has information and instructions for software, firmware, programs, algorithms, scripts, applications, etc. stored therein or thereon that may govern all or part of the methodology described herein. The processor, or each, electronic processor 106 may access the memory device 108 and execute and/or use that or those instructions and information to carry out or perform some or all of the functionality and methodology described herein.

The at least one memory device 108 may comprise a computer-readable storage medium (e.g. a non-transitory or non-transient storage medium) that may comprise any mechanism for storing information in a form readable by a machine or electronic processors/computational devices. Examples of the form include, without limitation: a magnetic storage medium (e.g. floppy diskette); optical storage medium (e.g. CD-ROM); magneto optical storage medium; read only memory (ROM); random access memory (RAM); erasable programmable memory (e.g. EPROM ad EEPROM); flash memory; or electrical or other types of medium for storing such information/instructions.

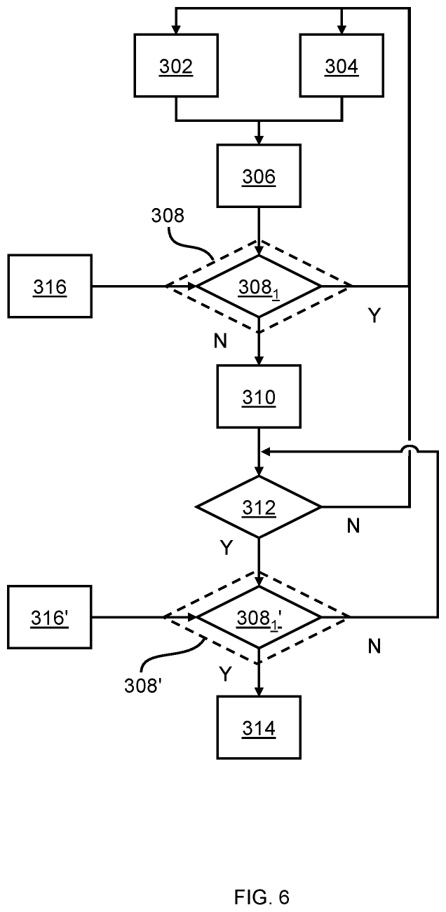

FIGS. 5 to 15 illustrate examples of methods 300, 300′ of controlling the automatic transmission 12 of the vehicle 1. The methods 300, 300′ may be performed by the control system 100 illustrated in FIG. 3. In particular, the memory 108 may comprise computer-readable instructions 110 which, when executed by the processor 106, perform the method 300.

FIG. 5 illustrates a first method 300 of controlling the automatic transmission 12 of the vehicle 1. The first method 300 can result in the cancellation of a gear shift if it is deemed inappropriate or detrimental to effect the specific gear shift (or a gear shift generally) in a current situation.

Blocks 302 and 304 respectively comprise receiving a signal indicative of a speed parameter (a speed parameter signal) and a signal indicative of an accelerator input (an accelerator input signal).

The speed parameter may be any speed parameter suitable for enabling a determination of a gear ratio in which to place the automatic transmission 12.

For example, the speed parameter may be a speed parameter of the vehicle 1, such as its longitudinal speed (a longitudinal direction being defined by an axis between the front and rear of the vehicle 1). Alternatively, the speed parameter may be a speed parameter of a powertrain component, such as a rotational speed of one or more of the wheels 34, or of a transmission output shaft 20, or of a transmission input shaft 18 (which may be measured from a rotational speed of a turbine of the torque converter 14), or of the engine 24 and/or the electric machine 26. In some examples, the speed parameter may be a ratio between foregoing parameters, particularly between those pertaining to speeds on either side of the gear set 16, such as a ratio between the vehicle's longitudinal speed and the engine/electric machine speed or a ratio between the wheel speed and the transmission input shaft speed.

In some examples the speed of the transmission output shaft 20 may be used because it may be measured within the automatic transmission system 10 and accordingly network latency and communication issues do not affect the speed parameter signal.

The accelerator input may be dependent on for example, accelerator pedal depression (APD) or autonomous driving torque demand from an automated driving system (ADS) or an advanced driver-assistance system (ADAS). The accelerator input may be indicative of a torque requested or to be requested of the propulsion system 22.

Block 306 comprises determining a target gear ratio based on the speed parameter and the accelerator input.

The target gear ratio may be determined with reference to an active shift map.

Shift maps define a plurality of regions of a parameter space which is spanned by the speed parameter and the accelerator input. Each of these regions is associated with a different gear ratio. The lowest (smallest) gear ratio provides the fastest transmission output speed for a given transmission input speed. The highest (largest) gear ratio provides the slowest transmission output speed for a given transmission input speed. Upshifting reduces the gear ratio whilst downshifting increases the gear ratio. The target gear ratio can be determined as a gear ratio associated with the region in which the point described by the values of the speed parameter and accelerator input lies. A gear ratio proposed by a shift map may however be further subjected to restrictions on gear availability and so the target gear ratio may instead be based on the output from a shift map.

A plurality of shift maps may be stored in the memory 108 of the control system 100. The shift map which will be active can be selected based on internal and external factors such as, for example: road load (a reflection of driving resistance calculated from weight, slope, or the like), driving style of the driver, the operating mode of the propulsion system 22. In some examples, multiple stored shift maps may be selected and interpolation between these performed to generate the active shift map. Additionally or alternatively, shift thresholds defined by the selected or interpolated shift map may be modified to compensate for, for example, engine speed limitation, altitude and temperature, reduced powertrain capability.

Block 308 comprises determining whether a shift inhibit condition is satisfied. A shift inhibit condition signal indicative of a shift inhibit condition being satisfied may be utilised to convey the shift inhibit conditions to the control system.

Examples of shift inhibit conditions include, without limitation:
being within a defined period of time from completion of a previous shift;
advanced driver-assistance systems (ADAS) features such as adaptive cruise control being active;
being engaged in downhill driving, or at least downhill driving above a threshold gradient (put another way, the gradient of the slope being traversed may be greater than 5%, or greater than 10%, for example);
a rate of decrease in the accelerator input exceeding a threshold rate (in an example, this rate of decrease is manifested in a driver lifting off the accelerator pedal of the vehicle at a rate exceeding a threshold rate);
being engaged in cornering, or at least cornering exceeding a threshold based on a lateral acceleration;
being engaged in reversing;
a propulsion system of the vehicle being in transition between predefined operating modes;
a different target gear ratio being determined based on a change to at least one of: the speed parameter, the accelerator input, or the active shift map; and
a rate of decrease in a powertrain torque exceeding a threshold rate.

Some shift inhibit conditions may apply only to upshifts, while some shift inhibit conditions may apply only to downshifts. Others may apply to both upshifts and downshifts.

If the shift inhibit condition is not satisfied (‘N’ path from block 308), the method 300 advances to block 310. Block 310 comprises outputting a signal (shift initiation signal) comprising instructions to cause initiation of a shift to the target gear ratio. A shift to the target gear ratio is therefore permitted by the method 300. Accordingly, failure to satisfy the shift inhibit condition can be seen as satisfaction of a shift permit condition, and vice versa.

If the shift inhibit condition is satisfied (‘Y’ path from block 308), no signal comprising instructions to cause initiation of a shift to the target gear ratio is output.

Accordingly, output of a signal comprising instructions to cause initiation of a shift to the target gear ratio, as at block 310, is dependent on the shift permit condition being satisfied (the shift inhibit condition not being satisfied).

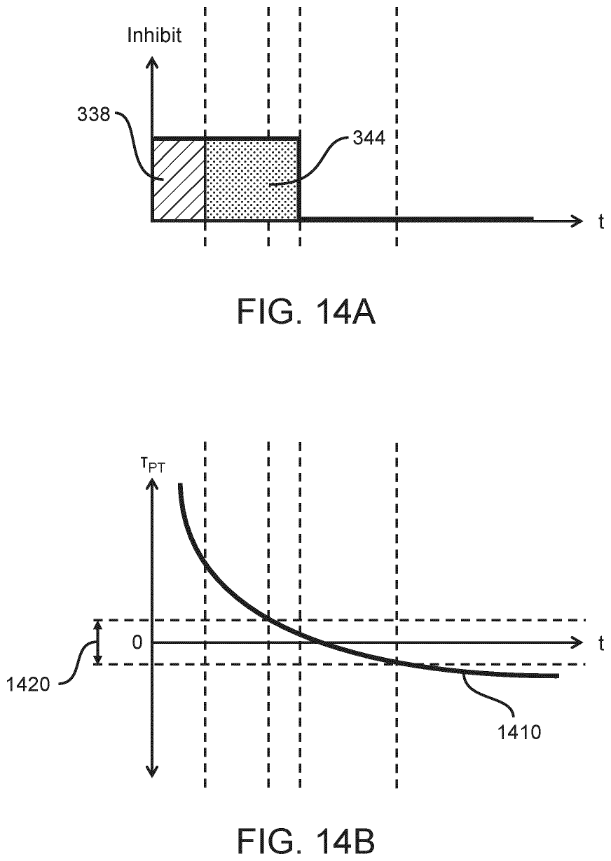

A second method 300′, which will be described in relation to FIG. 13, is concerned with additional actions which may be implemented when the shift inhibit condition is determined to have been satisfied at block 308.

In some examples, multiple shift inhibit conditions may be implemented. In the event that multiple shift inhibit conditions are implemented, advancement to block 310 may require that none of those multiple shift inhibit conditions are satisfied. Conversely, if any one or more of those multiple shift inhibit conditions are satisfied, no signal comprising instructions to cause initiation of a shift to the target gear ratio may be output.

Following block 310, block 312 comprises determining whether this point in the method 300 has been reached during a period between outputting the signal comprising instructions to cause initiation of the shift and a completion of the shift.

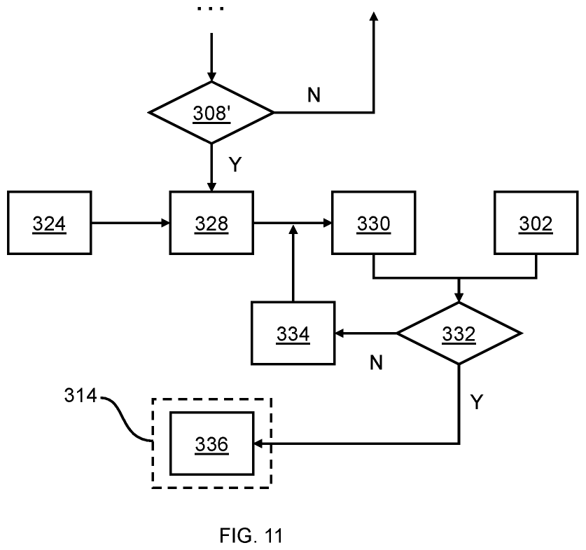

The output of a signal comprising instructions to cause the initiation of the shift and the completion of the shift do not necessarily mark the start and end of this period. This period may instead lie somewhere in between these two events. For example, the period may start upon output of the signal comprising instruction to cause initiation of the shift or may start sometime after output of this signal, triggered, for example, by performance of a shifting activity in service of effecting this shift. Likewise, the period may end upon completion of the shift or may end sometime before completion of the shift, either, for example, at some defined time after the start of the period or in response to a shifting activity performed in service of effecting the shift. This is further described in relation to FIG. 10A to E.

If block 312 has not been reached during a period between outputting the signal comprising instructions to cause initiation of the shift and completion of the shift, for example if it is reached after this period, then the method 300 advances via the ‘N’ path from block 312. This path does not comprise the output of a signal (a shift cancellation signal) which comprises instructions to cause cancellation of the shift. The method 300 does not intervene to prevent completion of the shift, so the target gear ratio may be assumed. The target gear ratio being selected may be confirmed by the receipt of a signal.

Where this period does not commence upon output of the signal comprising instructions to cause the initiation of the shift, block 312 may firstly comprise determining if this period (a time period) has started and, if not, continuing to check if this period has started. Once it is determined that this period has started, block 312 may secondly comprise determining whether this period has ended. The illustrated ‘Y’ and ‘N’ paths from block 312 are only representative of an outcome of the second of these determinations.

If block 312 has been reached during a period between outputting the signal comprising instructions to cause initiation of the shift and completion of the shift (‘Y’ path from block 312), the method 300 advances to block 308′. Block 308′ comprises determining whether a shift inhibit condition is satisfied.

Block 308′ comprises a repetition of at least some of the steps performed at block 308 at a later point in the method 300 so as to prevent shifts which were triggered before it was recognised that, in the current situation, they ought to have been inhibited.

Block 308′ may not involve repeating all of the steps performed at block 308. For example, block 308′ may comprise determining whether any of a subset of the shift inhibit conditions considered at block 308 are satisfied, rather than considering all of the shift inhibit conditions considered at block 308.

If the shift inhibit condition is satisfied during a period between outputting the signal comprising instructions to cause initiation of the shift and a completion of the shift (‘Y’ path from block 308′), the method 300 advances to block 314. Block 314 comprises outputting a signal comprising instructions to cause cancellation of the shift to the target gear ratio (which was initiated as a result of the signal output according to block 310).

In some examples, the signal comprising instructions to cause cancellation of the shift to the target gear comprises instructions to cause initiation of a shift to a current gear ratio. For example, the instructions to cause cancellation of the shift can be instructions to cause initiation of a shift to the current gear ratio. The instructions to cause initiation of the target gear ratio comprised in the signal output at block 310 can therefore be overridden by instructions to cause initiation of the current gear ratio in order to cancel the shift to the target gear ratio.

If the shift inhibit condition is not satisfied during this period between outputting the signal comprising instructions to cause initiation of the shift and a completion of the shift (‘N’ path from block 308′), no signal comprising instructions to cause cancellation of the shift is output. The method 300 returns to block 312. While within this period between outputting the signal comprising instructions to cause initiation of the shift and a completion of the shift, the method 300 will continue to determine if the shift inhibit condition is satisfied.

Accordingly, output of a signal comprising instructions to cause cancellation of the shift to the target gear ratio, as at block 314, is dependent on the shift inhibit condition being satisfied during a period between outputting the signal comprising instructions to cause initiation of the shift and a completion of the shift.

In some examples, multiple shift inhibit conditions may be implemented. In the event that multiple shift inhibit conditions are implemented, the method 300 can advance to block 314 if any one or more of those multiple shift inhibit conditions are satisfied during a period between outputting the signal comprising instructions to cause initiation of the shift and a completion of the shift. It may not be necessary that each and every one of those multiple shift inhibit conditions are satisfied during a period between outputting the signal comprising instructions to cause initiation of the shift and a completion of the shift in order to trigger output of the signal comprising instructions to cause cancellation of the shift to the target gear ratio. The shift inhibit conditions which can trigger output of the signal comprising instructions to cause cancellation of the shift may be a limited subset of those that may inhibit output of signal comprising instructions to cause initiation of the shift. If a shift inhibit condition is considered at block 308′ it will also be considered at block 308, but the reverse is not necessarily true. That is, there may be shift inhibit conditions considered at block 308 which are not considered at block 308′.

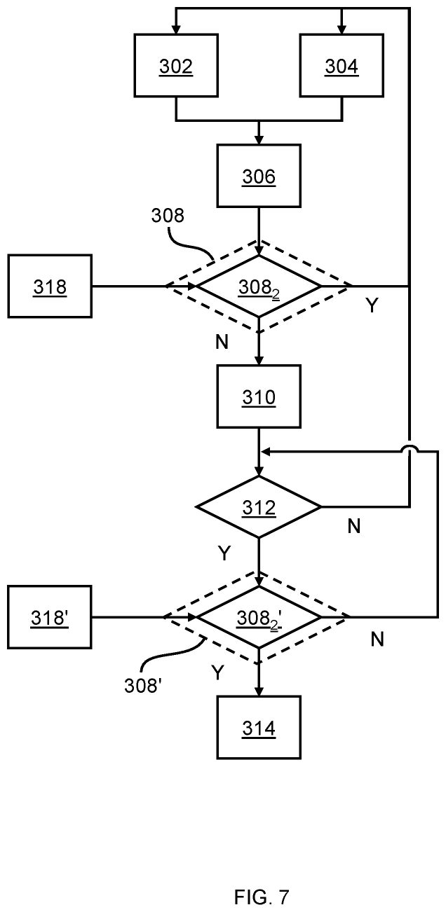

FIG. 6 illustrates an example of the method 300 in conjunction with a first shift inhibit condition.

The method 300 may be implemented such that the first shift inhibit condition is the only shift inhibit condition which, when satisfied during a period between outputting the signal comprising instructions to cause initiation of the shift and a completion of the shift, triggers the output of a signal comprising instructions to cause cancellation of the shift to the target gear ratio.

Alternatively, it may be the first of multiple shift inhibit conditions which, when satisfied during a period between outputting the signal comprising instructions to cause initiation of the shift and a completion of the shift, trigger the output of a signal comprising instructions to cause cancellation of the shift to the target gear ratio.

The first shift inhibit condition relates to a rate of change in accelerator input. Specifically, the first shift inhibit condition comprises a rate of decrease in the accelerator input exceeding a threshold rate. The corresponding shift permit condition comprises a rate of decrease in the accelerator input being below the threshold rate. In some examples, the threshold rate is a predetermined or dynamic rate of change of the accelerator input.

This may occur, for example, where there is a rapid reduction in accelerator input or a rapid backout of an accelerative manoeuvre, such as an overtake, regardless of whether these are actuated by a driver or ADS/ADAS. Such events may be known as “Fast Off” events. Rapid decrease in accelerator input without decrease or significant decrease in the speed parameter can result in the crossing of shift thresholds in a shift map, usually, but not always, upshift thresholds. However, the rapid decrease in accelerator input may actually suggest a highly transient situation where it is unclear what the next accelerator input will be. It may be preferable to avoid shifting to another gear ratio in this situation as the shift may need to be almost immediately reversed.

FIG. 6 depicts block 308 comprising block 308₁. Block 308₁ comprises determining whether a rate of decrease in the accelerator input exceeds the threshold rate.

The combination of block 310 with block 308₁ provides output of a signal comprising instructions to cause initiation of a shift to the target gear ratio in dependence on a rate of decrease in the accelerator input being below the threshold rate.

FIG. 6 depicts block 308′ comprising block 308₁′. Block 308₁′ comprises determining whether a rate of decrease in the accelerator input exceeds the threshold rate. In its combination with block 312, block 308₁′ comprises determining whether a rate of decrease in the accelerator input exceeds the threshold rate during a period between outputting the signal comprising instructions to cause initiation of the shift and a completion of the shift.

The combination of block 314 with blocks 308₁′ and 312 provides output of a signal comprising instructions to cause cancellation of the shift to the target gear ratio in dependence on a rate of decrease in the accelerator input exceeding the threshold rate during a period between outputting the signal comprising instructions to cause initiation of the shift and a completion of the shift.

Accordingly, implementation of the method 300 can consistently prevent shifting in highly transient situations.

The method 300 comprises, at blocks 316 and 316′, receiving a signal (an accelerator input rate signal) indicative of a rate of change in the accelerator input or determining a rate of change in accelerator input from changes in the accelerator input (obtained via block 304) over time.

The rate of change in the accelerator input received or determined at block 316 is provided as an input for the determination taking place at block 308₁. The rate of change in the accelerator input received or determined at block 316′ is provided as an input for the determination taking place at block 308₁′.

Both blocks 308₁ and 308₁′ determine whether a rate of decrease in the accelerator input is above or below the threshold rate using the rate of change in the accelerator input output respectively from blocks 316 and 316′.

The threshold rate of decreasing accelerator input may be fixed in some examples. In others it may be based on at least one of, for example, an initial accelerator input value from which the current decrease began; a driving style of the driver; a vehicle speed; or a gradient of the road.

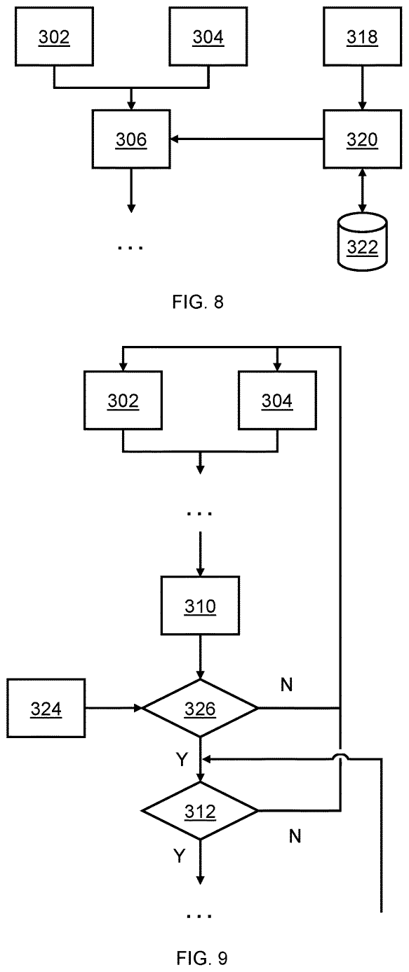

FIG. 7 illustrates an example of the method 300 in conjunction with a second shift inhibit condition.

The method 300 may be implemented such that the second shift inhibit condition is the only shift inhibit condition which, when satisfied during a period between outputting the signal comprising instructions to cause initiation of the shift and a completion of the shift, triggers the output of a signal comprising instructions to cause cancellation of the shift to the target gear ratio.

Alternatively, it may be one of multiple shift inhibit conditions which, when satisfied during a period between outputting the signal comprising instructions to cause initiation of the shift and a completion of the shift, trigger the output of a signal comprising instructions to cause cancellation of the shift to the target gear ratio.

The second shift inhibit condition relates to a status of the propulsion system 22 of the vehicle 1. Specifically, the second shift inhibit condition comprises the propulsion system 22 being in transition between predefined operating modes. The corresponding shift permit condition comprises the propulsion system 22 being in a predefined operating mode.

An electric machine 26 can be run at higher speeds than the engine 24 for similar driving conditions. Accordingly, the automatic transmission 12 should be in a higher gear ratio in electric mode than in parallel hybrid mode for a given speed. A transition between predefined operating modes being triggered therefore indicates that a shift in gear ratio will soon be required. It may be preferred to avoid shifting gear ratio in this situation as such shifts may need to be almost immediately reversed.

In this example, block 308 comprises block 308₂. Block 308₂ comprises determining whether the propulsion system 22 is in transition between predefined operating modes.

The combination of block 310 with block 308₁ provides output of a signal comprising instructions to cause initiation of a shift to the target gear ratio in dependence on the propulsion system being in a predefined operating mode, and accordingly is not in transition between predefined operating modes. In some examples, the propulsion system comprises a plurality of predefined operating modes, and one or more transition modes, wherein the transition modes are defined as being modes between two of the plurality of predefined operating modes. The transition modes are indicative of when the propulsion system is in transition. In these examples, therefore, the propulsion system is not in transition when the propulsion system is not in a transition mode.

In this example, block 308′ comprises block 308₂′. Block 308₂′ comprises determining whether the propulsion system 22 is in transition between predefined operating modes. In its combination with block 312, block 308₂′ effectively comprises determining whether the propulsion system 22 is in transition between predefined operating modes during a period between outputting the signal comprising instructions to cause initiation of the shift and a completion of the shift. Transition between operating modes may be determined by defining a mode between two of the plurality of predefined operating modes as a transition mode, and as such the determination may occur in dependence on the propulsion status signal. The propulsion system being ‘in transition’may equally be defined by the determination that the operating mode is the transition mode.

The combination of block 314 with blocks 308₂′ and 312 provides output of a signal comprising instructions to cause cancellation of the shift to the target gear ratio in dependence on the propulsion system 22 being in transition between predefined operating modes during a period between outputting the signal comprising instructions to cause initiation of the shift and a completion of the shift. The period may be a time period, the time period being defined as between outputting the signal comprising instructions to cause initiation of the shift and a completion of the shift. The time period having not elapsed is understood to mean that the time period is ongoing, and the shift cancellation signal is output if the determination occurs after the output of the shift initiation signal and before the completion of the shift.

The method 300 comprises, at blocks 318 and 318′, receiving one or more signals (propulsion status signals) indicative of a status of the propulsion system 22 of the vehicle 1. The status can indicate which of the predefined operating modes the propulsion system 22 is in or whether it is in transition and in some examples between which predefined operating modes it is transitioning.

The status of the propulsion system 22 received at block 318 is provided as an input for the determination taking place at block 308₂. The status of the propulsion system 22 received at block 318′ is provided as an input for the determination taking place at block 308₂′.

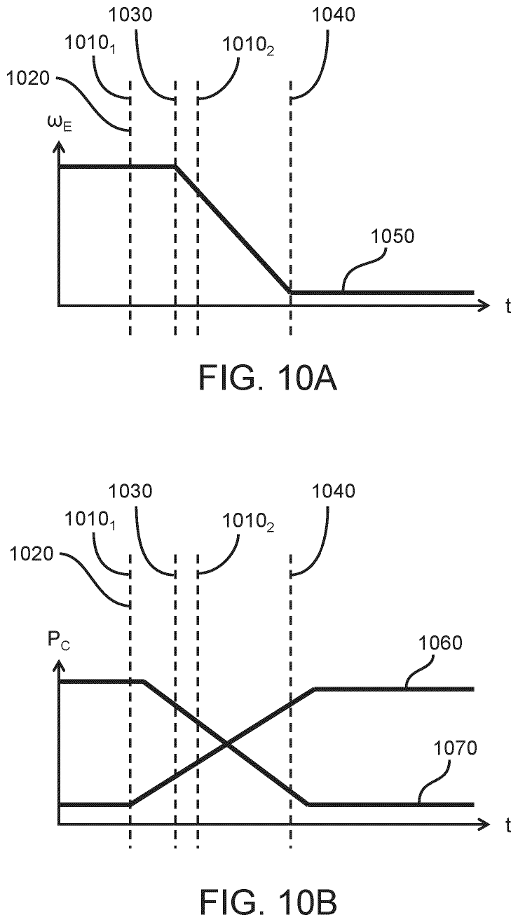

The one or more signals indicative of the status of the propulsion system 22 may additionally be used, alongside the speed parameter and the accelerator input, in determining the target gear ratio at block 306. The one or more signals may directly indicate the status of the propulsion system 22 or may, for example, indicate the status of the coupling clutch 25 to ascertain if the engine 24 is mechanically connected to the transmission 12 or not in view of which the status of the propulsion system 22 can be determined. As illustrated in FIG. 8, these signal(s) can be used at block 320 to select a shift map. The shift map is selected based on an operating mode of the propulsion system 22. The shift map can be selected from a database 322 of shift maps stored in the memory 108 of the control system 100. Block 306 can comprise determining the target gear ratio based on an output from the selected shift map which corresponds to instantaneous values of the speed parameter and the accelerator input.

In the figures, ellipses indicate where blocks of the method 300 have been omitted from illustrations for conciseness of said illustrations. An ellipsis is used to indicated that the non-depicted blocks are not (necessarily) omitted from the method 300 in the illustrated example. In FIG. 8 the ellipsis indicates that none of the blocks subsequent to 306 in FIG. 7 are omitted from the method 300.

In some examples, block 308′ comprises four shift inhibit conditions. These four shift inhibit conditions are:
the first and second shift inhibit conditions described in relation to FIGS. 6 and 7 in the foregoing;
a different target gear ratio being determined based on a change to at least one of: the speed parameter, the accelerator input, or the active shift map; and
a rate of decrease in a powertrain torque exceeding a threshold rate.

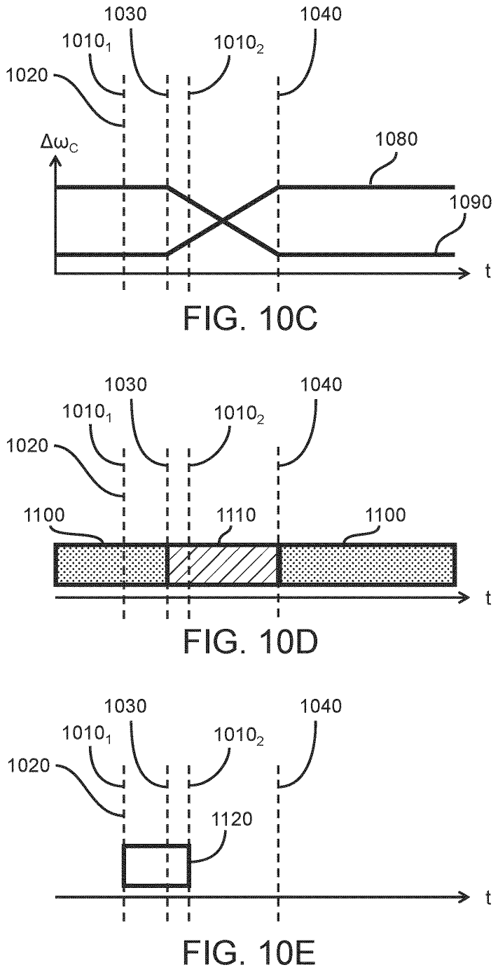

The following FIGS. 9-12 illustrate additional, optional features of the first method 300, applicable to any or all shift inhibit conditions.

In some examples the method 300 may be focussed on facilitating the cancellation of an upshift (target gear ratio lower than current gear ratio). If a downshift is proposed it may imply that there is not enough wheel torque to maintain a given situation. In highly transient situations it may be preferrable to allow a downshift, even if an upshift might almost immediately be proposed, so as to assume a lower gear ratio suitable for rapid acceleration. Where the propulsion system is transitioning from parallel hybrid mode to electric mode, a downshift will be expected when the electric mode is assumed, so it may be preferrable to allow a downshift even during the transition. To this end the output of the signal comprising instructions to cause cancellation of the shift to the target gear ratio may be dependent on the target gear ratio being lower than the current gear ratio as shown in FIG. 9.

According to the example illustrated in FIG. 9, following the output of the signal comprising instructions to cause initiation of the shift to the target gear ratio at block 310, the method 300 advances to block 312 via an intervening block 326.

Block 326 comprises determining whether the target gear ratio is lower than the current gear ratio.

A signal (a current gear ratio signal) indicative of the current gear ratio is received at block 324 and is provided as an input for the determination taking place at block 326.

If the target gear ratio is lower than the current gear ratio, the method 300 advances to block 312 via the ‘Y’ path from block 326.

If the target gear ratio is higher than the current gear ratio, the method 300 does not proceed to block 312, nor from there onwards towards block 314.

Accordingly, in this example, the method 300 does not facilitate cancellation of a shift to a target gear ratio if this represents a downshift.

In some examples, where the output of the signal comprising instructions to cause cancellation of the shift to the target gear ratio is made dependent on the shift being an upshift, the second shift inhibit condition can be adapted to require that the propulsion system 22 is in transition from a parallel hybrid mode to an electric mode. For a transition in the reverse direction, it may be acceptable to allow upshifts as an upshift can be expected when the parallel hybrid mode is assumed.

In the example of FIG. 9 the ellipses indicate that none of the blocks between 302/304 and 310 or the blocks after 312, which have been described in the foregoing, are omitted. Any of these blocks which have been described as being optional in the foregoing are also optional in the example of FIG. 9.

As noted in relation to block 312, the output of the signal comprising instructions to cause the initiation of the shift and the completion of the shift do not necessarily mark the start and end of the period in which determination that a shift inhibit condition is satisfied will trigger output of the signal comprising instruction to cause cancellation of the shift. This period may instead lie somewhere in between these two events.

To aid understanding of the start and end points, reference is be made to FIG. 10A to E which illustrate example timings of shifting activities.

FIG. 10A shows engine speed ω_{E} on the y-axis with respect to time t on the x-axis. FIG. 10A depicts an example of the shifting activity of reducing the rotational speed input into the transmission, in this instance by reducing the engine speed, though it will be appreciated that this could be additionally or alternatively accomplished by reducing the electric machine speed.

FIG. 10B shows clutch pressure P_{C} on the y-axis with respect to time t on the x-axis. FIG. 10B depicts an example of the shifting activity of removing torque from an offgoing gear (one which is part of a gear train providing the current gear ratio but not part of a gear train providing the target gear ratio) as it is uncoupled from the torque path by decreasing the pressure at a corresponding offgoing clutch (line 1070) and an example of the shifting activity of applying torque to an oncoming gear (one which is not part of a gear train providing the current gear ratio but is part of a gear train providing the target gear ratio) as it is coupled to the torque path by increasing the pressure at a corresponding oncoming clutch (line 1060). The offgoing and oncoming clutches are balanced to hand torque from one to the other.

FIG. 10C shows clutch delta speed Δω_{C} (the speed delta across a clutch) on the y-axis with respect to time t on the x-axis. FIG. 10C depicts an example of the shifting activity of synchronising an oncoming gear with the torque path via the decreasing speed delta across the corresponding oncoming clutch (line 1090) and the offgoing gear becoming unsynchronised as it is uncoupled via the increasing speed delta across the corresponding offgoing clutch (line 1080).

FIG. 10D depicts an example of the time periods when the automatic transmission 12 is in a synchronised state, referenced as 1100, and when the automatic transmission 12 is in an unsynchronised state, referenced as 1110. The automatic transmission 12 is in a synchronised state 1110 when there is zero delta speed across any of the clutches involved in making the offgoing or oncoming gear ratios.

FIG. 10E depicts an example of the period, referenced as 1120, considered at block 312. This period 1120 is the period during which satisfaction of an appropriate shift inhibit condition can trigger output of a signal comprising instructions to cause cancellation of the shift to the target gear ratio (which was initiated as a result of the signal output according to block 310). It can be seen how this period 1120 is temporally aligned with the shifting activities and state of the automatic transmission 12 depicted in FIG. 10A to C and 10D respectively.

Line 1020 represents the time at which the signal comprising instructions to cause the initiation of the shift is output. Coinciding with this time is the initial increase in pressure at the oncoming clutch (line 1060).

Line 1030 represents the time when the speed delta across at least an offgoing clutch (line 1080) becomes non-zero. At this time, the automatic transmission 12 leaves synchronisation as seen in the transition from the synchronised state 1100 to the unsynchronised state 1110. Coinciding with this time is the initial decrease in speed delta across the oncoming clutch (line 1090).

Line 1040 represents the time when the speed delta across at least an oncoming clutch (line 1090) becomes zero. At this time, the automatic transmission 12 returns to synchronisation as seen in the transition from the unsynchronised state 1110 to the synchronised state 1100.

Lines 1010₁ and 1010₂ represent the timing of the start and end of the period 1120 in this example.

Line 1010₁ is contemporaneous with line 1020 in this example, representing that the period 1120 begins with the output of the signal comprising instructions to cause the initiation of the shift. In another example, however, the period 1120 may begin when a speed delta across an off-going clutch during the shift becomes non-zero, which time is represented by line 1030.

The period 1120 may be of a predefined duration, for example, based on typical times for shifting activities. The duration will be defined so as to extend beyond the point at which the automatic transmission 12 leaves synchronisation (past line 1030), however the exact duration will be down to an individual transmission type and shift.

Alternatively, the period may be dynamically defined according to the monitored timing of shifting activities.

In some examples the period 1120 ends when or before a speed delta across an oncoming clutch during the shift is reduced to zero. In the illustrated example it ends before the speed delta across an oncoming clutch during is reduced to zero as shown by line 1010₂. It may be desirable to avoid cancelling the shift close to the point at which the speed delta across an oncoming clutch during the shift is reduced to zero (line 1040) as this late in the shift, cancellation may cause shift quality concerns such as, for example, the driver perceiving a “stumble”. In some examples, the period 1120 ends when or before an oncoming clutch pressure has reached 50% of its maximum, as per line 1010₂. However, it will be appreciated that when the period 1120 ends may be down to an individual transmission type and shift.

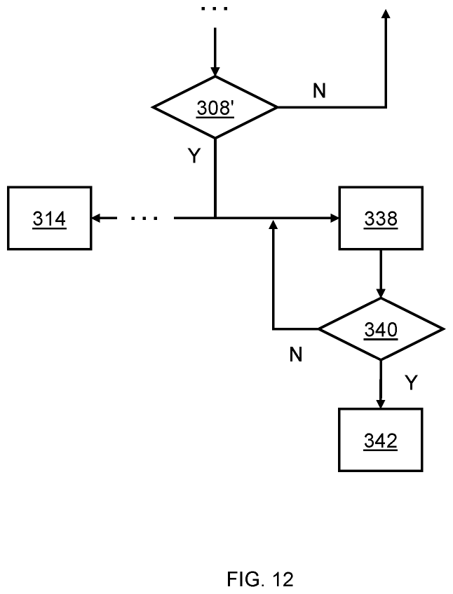

As the current gear ratio is not determined at block 306 based on the speed parameter and accelerator input, the current gear ratio may not be an appropriate gear ratio for the current situation. The instructions to cause cancellation of the shift to the target gear ratio may be configured to take account of that. FIG. 11 illustrates an example of the method 300 where the suitability of the current gear ratio is assessed and the signal output at block 314 is configured to include instructions accounting for this if it is not suitable.

According to the example illustrated in FIG. 11, following determination that a shift inhibit condition is satisfied during a period between outputting the signal comprising instructions to cause initiation of the shift and a completion of the shift at block 308′, the method 300 advances to block 328.

Block 328 comprises setting the current gear ratio as an initial proposal for an alternative gear ratio to be established in place of the target gear ratio.

The current gear ratio is determined or received at block 324 as has been described in the foregoing. However, it will also be appreciated that receiving or determining the current gear ratio may be a repetition of the step in the example of FIG. 9 rather than necessarily the same step.

Block 330 comprises determining an operating window for the speed parameter in the alternative gear ratio.

An operating window for the speed parameter in a particular gear ratio is different to a region of the active shift map associated with this gear ratio. Regions of shift maps associated with gear ratios are calibrated to optimise shift scheduling whilst operating windows are defined based on the capability of operating in that gear ratio in the current situation. An operating window for a particular gear ratio may be at least as broad as the regions associated with that gear ratio in all shift maps which could be selected in the current situation.

Operating windows for the speed parameter may be stored in the memory 108 of the control system 100 and the one corresponding to the alternative gear ratio retrieved at block 330.

Block 332 comprises determining if the instantaneous value of the speed parameter is within the operating window determined at block 330.

The instantaneous value of the speed parameter is obtained from the signal received a block 302. As illustrated in FIG. 11, block 302 may represent a repetition of the step described in the foregoing examples rather than necessarily the same step.

If the instantaneous value of the speed parameter is determined to be outside of the operating window, the method 300 advances to block 334. Block 334 comprises setting the alternative gear ratio equal to the next gear ratio between the current gear ratio and the target gear ratio and the method 300 subsequently returns to block 330. Accordingly, the method 300 increments the alternative gear ratio one step towards the target gear ratio from the current gear ratio until an alternative gear ratio is found which has an operating window for the speed parameter that the instantaneous value of the speed parameter falls within.

Accordingly, blocks 328 to 334 determine, in dependence on an instantaneous value of the speed parameter being outside of an operating window for the speed parameter in the current gear ratio, an alternative gear ratio which is a closest gear ratio to the current gear ratio for which a corresponding operating window encompasses the instantaneous value of the speed parameter.

If the instantaneous value of the speed parameter is determined to be within the operating window at block 332, the method 300 advances to block 336. Block 336 comprises outputting a signal comprising instructions to cause initiation of a shift to the alternative gear ratio. These instructions may be comprised within the signal comprising instructions to cause cancellation of the shift to the target gear ratio at block 314.

In the example of FIG. 11 the ellipsis indicates that none of the blocks before 308′, which have been described in the foregoing, are omitted. Any of these blocks which have been described as being optional in the foregoing are also optional in the example of FIG. 11.

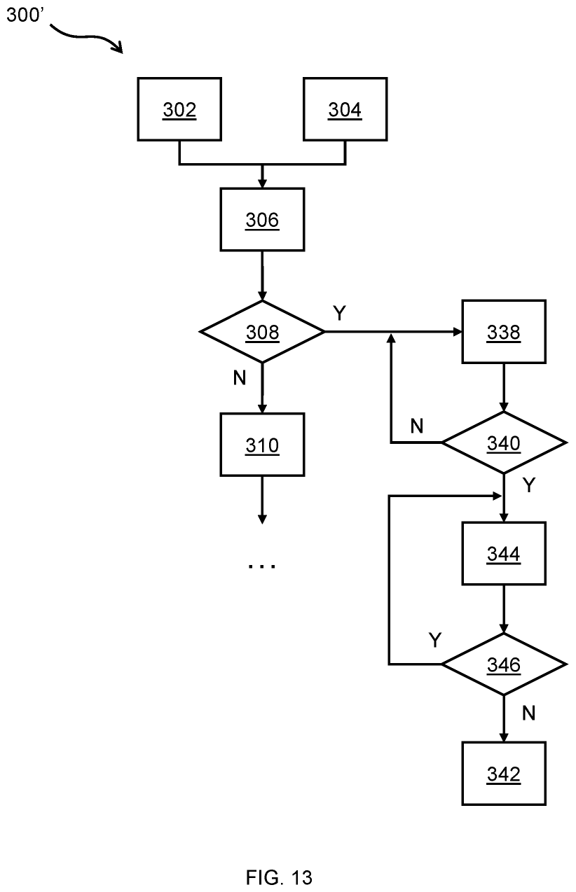

Once it has been determined that a shift to the target gear ratio should not proceed, it may be desirable to prevent the shift being instructed again by earlier blocks in the method 300, at least while the current situation is expected to persist. FIG. 12 illustrates an example of the method 300 where an inhibit is put in place and remains after the output of the signal comprising instructions to cause cancellation of the shift.

FIG. 12 illustrates a first branch of the ‘Y’ path from block 308′ which includes block 314 as described in the foregoing examples. The ellipsis in this branch indicates the blocks following 308′ described in relation to FIG. 11 may optionally be included in this example.

In a second branch of the ‘Y’ path from block 308′, the method 300 advances to block 338. Block 338 comprises inhibiting output of a further signal comprising instructions to cause initiation of a shift to the target gear ratio.

Following block 338, block 340 comprises determining whether a period of time has elapsed.

In some examples, the period commences with the determination that shift inhibit condition is satisfied. In others examples, the predetermined period commences after the output of the signal comprising instructions to cause cancellation of the shift to the target gear ratio.

The period of time may be determined based on the shift inhibit condition which has been satisfied. That is, depending on which shift inhibit condition is satisfied, the method 300 may inhibit the output of a further signal comprising instructions to cause initiation of a shift to the target gear ratio for different lengths of time. The period of time may be further determined based on at least one of, for example, the current gear ratio; a driving style of the driver; an engine/electric machine speed; or a gradient of the road.

While the period of time has not elapsed (‘N’ path from block 340), the method 300 returns to block 338 to maintain the inhibit.

Accordingly, the combination of blocks 340, 338, and 308′ provides inhibiting of an output of a further signal comprising instructions to cause initiation of a shift to the target gear ratio for at least this period of time after the shift inhibit condition is satisfied.

After this period of time has elapsed (‘Y’ path from block 340), the method 300 does not return to block 338 to maintain the inhibit. In some examples the method 300 instead advances to block 342 which comprises removing the inhibit. In examples where a second method 300′, which will be described in relation to FIG. 13, is additionally implemented, the inhibit may be further extended until a further condition is satisfied.

In some examples, the inhibit may be removed before the period of time has elapsed if other exit conditions are satisfied. For example, if either of the current values of the speed parameter or accelerator input are determined to be outside of respective operating windows for current gear ratio, the inhibit may be removed regardless of whether the period of time has elapsed.

In some examples, the inhibit applies not only to the output of a signal comprising instructions to cause initiation of a shift to the target gear ratio, but more generally to the output of any signal comprising instructions to cause initiation of a shift to any gear ratio.

FIG. 13 illustrates a second method 300′ of controlling the automatic transmission 12 of a vehicle 1. The second method 300′ can extend the inhibition of a gear shift to avoid completion of the shift during lash crossing.

Lash crossing occurs when the direction of powertrain torque is reversed. The reversal of the direction of torque causes backlash whereby lost motions of mechanical components of the drivetrain are taken up. This makes it challenging to control the synchronisation and coupling of oncoming gears during this period. Furthermore, completing a shift connects more mechanical components into the torque path, with each contributing more lost motion to be taken up. This can make backlash particularly perceptible as a jolt or jerk, giving the impression of a poor-quality shift. Lash crossing is considered to be ongoing during the period of time when the powertrain torque is crossing a range of values around 0 Nm known as the lash region.

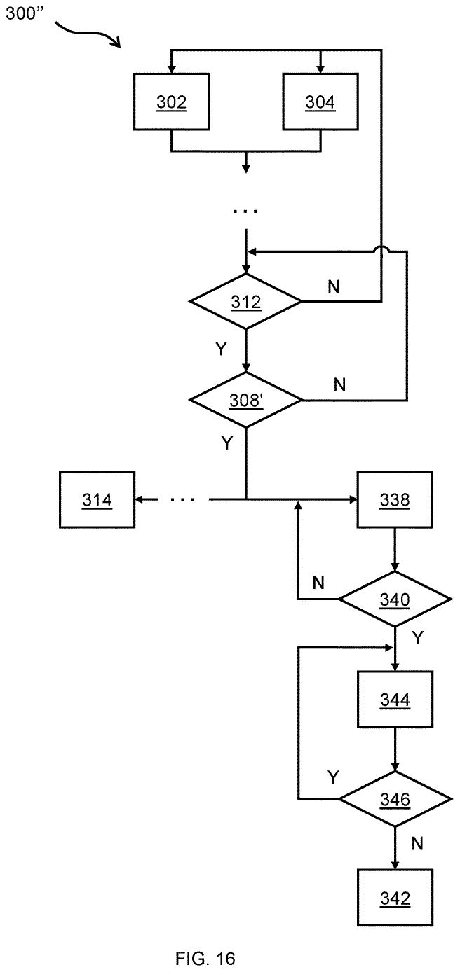

The second method 300′ shares a number of blocks with the first method 300. The first and second methods 300, 300′ may be implemented independently of one another. The first method 300 may be implemented without implementation of the second method 300′ and the second method 300′ may be implemented without implementation of the first method 300. Alternatively, the first and second methods 300, 300′ may be combined into a single method, as shown in FIG. 16.

As illustrated in FIG. 13, blocks 302 and 304 respectively comprise receiving a signal indicative of a speed parameter and a signal indicative of an accelerator input. These are as described in the foregoing examples relating to the first method 300.

Block 306 comprises determining a target gear ratio based on the speed parameter and the accelerator input. This is as described in the foregoing examples relating to the first method 300.

Block 308 comprises determining whether a shift inhibit condition is satisfied. This is as described in the foregoing examples relating to the first method 300.

If a shift inhibit condition is not determined to be satisfied (‘N’ path from block 308), the method 300 advances to block 310. Block 310 comprises outputting a signal comprising instructions to cause initiation of a shift to the target gear ratio. This is as described in the foregoing examples relating to the first method 300.

The method 300′ may optionally continue from block 310 as per any of the foregoing examples described in relation to the first method 300, as indicated by the ellipsis.

Alternatively, the method 300′ may not continue further after block 310. That is, after permitting a shift to the target gear ratio, the method 300′ may not consider whether the shift inhibit condition is satisfied during a period between outputting the signal comprising instructions to cause initiation of the shift and a completion of the shift, nor cause cancellation of the shift on this basis.

If a shift inhibit condition is determined to be satisfied (‘Y’ path from block 308), the method 300′ advances to block 338. Block 338 comprises inhibiting output of a signal comprising instructions to cause initiation of a shift to the target gear ratio.

Following block 338, block 340 comprises determining whether an initial period of time has elapsed.

The initial period of time may be determined based on the shift inhibit condition which has been satisfied. That is, depending on which shift inhibit condition is satisfied, the method 300′ may initially inhibit the output of a further signal comprising instructions to cause initiation of a shift to the target gear ratio for different lengths of time. The initial period of time may be further determined based on at least one of, for example, the current gear ratio; a driving style of the driver; an engine/electric machine speed; or a gradient of the road.

While the initial period of time has not elapsed (‘N’ path from block 340), the method 300′ returns to block 338 to maintain the inhibit.

Accordingly, the combination of blocks 340, 338, and 308 provides inhibiting of an output of a signal comprising instructions to cause initiation of a shift to the target gear ratio for an initial period of time in dependence on a shift inhibit condition being satisfied.

In some examples, the inhibit may be removed before the initial period has elapsed if other exit conditions are satisfied. For example, if either of the current values of the speed parameter or accelerator input are determined to be outside of respective operating windows for current gear ratio, the inhibit may be removed regardless of whether the initial period has elapsed.

After the initial period has elapsed (‘Y’ path from block 340), the method 300′ advances to block 344. Block 344 also comprises inhibiting output of a signal comprising instructions to cause initiation of a shift to the target gear ratio. The inhibit is therefore not removed at the end of the initial period. The inhibit remains in place until a further condition is satisfied.

Following block 344, block 346 comprises determining whether an instantaneously initiated shift will complete during lash crossing.

If it is determined that an instantaneously initiated shift will complete during lash crossing (‘Y’ path from block 346), the method 300′ returns to block 344 to maintain the inhibit.

If it is determined that an instantaneously initiated shift will not complete during lash crossing (‘N’ path from block 346), the method 300′ does not return to block 344 to maintain the inhibit. The method instead advances to block 342 which comprises removing the inhibit.

Accordingly, the combination of block 346 with block 344 provides inhibiting of an output of a signal comprising instructions to cause initiation of a shift to the target gear ratio after the initial period until it is determined that an instantaneously initiated shift will not complete during lash crossing.

In some examples, the inhibit applies not only to the output of a signal comprising instructions to cause initiation of a shift to the target gear ratio, but more generally to the output of any signal comprising instructions to cause initiation of a shift to any gear ratio.

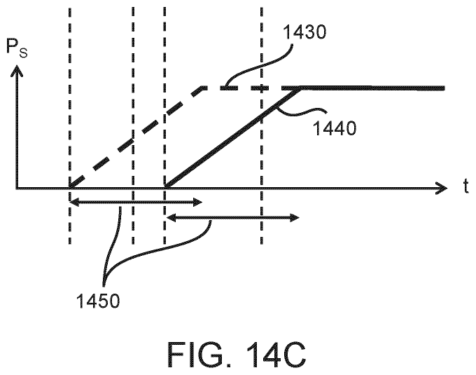

FIG. 14A to C illustrate the result of applying the second method 300′ to control the automatic transmission 12.

FIG. 14A shows whether an inhibit is active or not on the y-axis with respect to time t on the x-axis. FIG. 14A depicts an example of the timing of the initial inhibit applied at block 338 followed by the inhibit applied at block 344 to extend the initial inhibit.

FIG. 14B shows powertrain torque T_{PT} on the y-axis with respect to time t on the x-axis. FIG. 14B depicts an example of a trajectory 1410 followed by a powertrain torque decline which involves lash crossing. The lash crossing occurs during the period of time where the powertrain torque crosses the lash region 1420.

The powertrain torque is the torque provided at the input shaft 18 to the automatic transmission 12, and thus includes torque applied to the drivetrain by the engine 24 and/or torque applied to the drivetrain by the electric machine 26. The powertrain torque, or instantaneous powertrain torque, may be conveyed to the control system by way of a powertrain torque signal. The powertrain torque signal is indicative of an instantaneous powertrain torque.

FIG. 14C shows shift pressure P_{S} on the y-axis with respect to time t on the x-axis. FIG. 14C depicts examples of a first shift pressure profile 1430 associated with a first shift which can be seen to complete during lash crossing and a second shift pressure profile 1440 associated with a second shift which can be seen to complete after lash crossing. The duration 1450 of each of these shifts is a known quantity.

The first shift is permitted if only the inhibit at block 338 is implemented. This is because the first shift is initiated after the end of the initial period of time. This first shift is inhibited by the implementation of the inhibit at block 344. This is because it can be determined that the first shift would complete during lash crossing in view of the known duration of a shift.

The second shift is initiated after it has been determined that an instantaneously initiated shift will not complete during lash crossing and the inhibit at block 344 has accordingly ended. This second shift is therefore not inhibited by implementation of the inhibit at either of blocks 338 and 344.

The trajectory 1410 followed by the powertrain torque decline for different accelerator inputs and gear ratios can be derived from experimental data, theoretical modelling, or a combination thereof. Accordingly, for a current accelerator input and current gear ratio, a particular trajectory can be expected. Given an expected trajectory 1410 and a known duration of a shift 1450, it can be determined which values of powertrain torque will be expected to decline to values within the lash region 1420 over the duration of a shift. These values, for different accelerator inputs and gear ratios, may be recorded in a look-up table stored within the memory 108 of the control system 100 to enable the determining of whether an instantaneously initiated shift will complete during lash crossing at block 346. Therefore, based on inputs comprising the instantaneous value of the powertrain torque, the accelerator input, and the current gear ratio, it can be determined if an instantaneously initiated shift will complete during lash crossing.

Alternatively, by monitoring the change in powertrain torque during the initial period of time or during another window before the elapsing of this initial period, the expected trajectory 1410 can be forecast or the time until the powertrain torque declines to values within the lash region 1420 can be directly predicted. Other methods of determining whether an instantaneously initiated shift will complete during lash crossing may be envisaged.

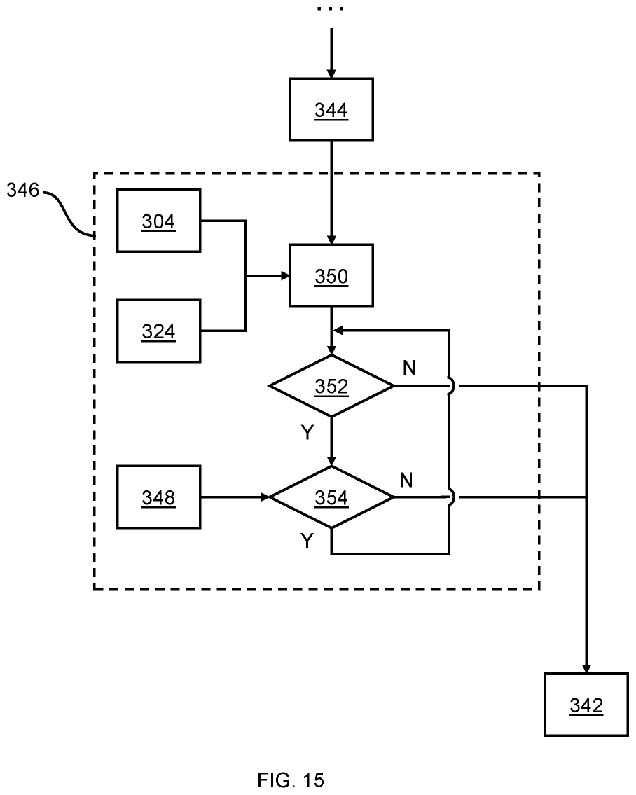

FIG. 15 illustrates an example implementation of block 346. That is, FIG. 15 illustrates an example of how to determine whether an instantaneously initiated shift will complete during lash crossing and when it will not.

While the inhibit is in place according to block 344, the method 300′ advances to block 350. Block 350 comprises determining the upper and lower limits of a predetermined range of values of powertrain torque that are expected to decline to values within the lash region 1420 over the duration of a shift, provided a powertrain torque decline follows a trajectory 1410 expected at the accelerator input and the current gear ratio.

The determination at block 350 can comprise obtaining the limits from a look-up table stored in the memory 108 of the control system 100. The lookup table may be organised by accelerator input and gear ratio so the current accelerator input and current gear ratio may be used as an index to the lookup table to extract the corresponding limits. Determining from the look-up table may be performed in dependence on the accelerator input signal and the current gear ratio signal, which are indicative of the accelerator input and current gear ratio respectively.

The accelerator input is received at block 304′ as has been described in relation to block 304. Block 304′ represents a repetition of the step performed at block 304 since at least the initial period of time in which an inhibit has been applied has passed and the accelerator input may have changed during this time.

The current gear ratio is determined or received at block 324 as has been described in the foregoing. However, it will also be appreciated that receiving or determining the current gear ratio may be a repetition of the step in the example of FIG. 9 and/or the step in FIG. 11 rather than necessarily the same step.

At block 354 it is determined whether an instantaneous value of the powertrain torque is between the limits determined at block 350, and thus within the predetermined range of values of powertrain torque,

If the instantaneous value of the powertrain torque is between the limits determined at block 350 (‘Y’ path from block 354) then the inhibit at block 344 is maintained and the method 300′ continues to loop block 354 until it is determined that an instantaneous value of the powertrain torque is no longer between the limits.

If the instantaneous value of the powertrain torque is not between the limits (‘N’ path from block 354, the method advances to block 342 where the inhibit is removed.

A signal (powertrain torque signal) indicative of the powertrain torque is received at block 348 and is provided as an input for the determination taking place at block 354.

In some examples there is a maximum duration of inhibiting output of a signal comprising instructions to cause initiation of a shift to the target gear ratio. Optionally block 352 may be included in the method 300′ between blocks 350 and 354. Block 352 comprises determining whether or not the maximum duration has elapsed. If it has, the method 300′ stops looping block 354 and advances to block 342 where the inhibit is removed.

In the example of FIG. 15 the ellipsis indicates that none of the blocks before 344, which have been described in the foregoing, are omitted. Any of these blocks which have been described as being optional in the foregoing are also optional in the example of FIG. 15.

Finally, FIG. 16 illustrates the first method 300 and the second method 300′ combined into a single method 300″.

In the example of FIG. 16 the ellipsis indicates that none of the blocks before 312, which have been described in the foregoing, are necessarily omitted. Any of these blocks which have been described as being optional in the foregoing are also optional in the example of FIG. 16.

In this example, the response to determining that a shift inhibit condition is satisfied at block 308′ is two-fold.

A signal comprising instructions to cause cancellation of the shift to the target gear ratio is output as described in relation to block 312 in the foregoing examples. The ellipsis in this branch indicates the blocks following 308′ described in relation to FIG. 11 may optionally be included in this example.

Additionally, the output of a further signal comprising instructions to cause initiation of a shift to the target gear ratio is inhibited for an initial period and then, subsequently, until it is determined that an instantaneously initiated shift will not complete during lash crossing as described in relation to blocks 338, 340, 344, 346, and 342 in the foregoing examples.

It will be appreciated that embodiments of the present invention can be realised in any suitable form of hardware, software or a combination of hardware and software. For example, it is contemplated that the present invention is not limited to being implemented by way of programmable processing devices, and that at least some of, and in some embodiments all of, the functionality and or method steps of the present invention may equally be implemented by way of non-programmable hardware, such as by way of non-programmable ASIC, Boolean logic circuitry, etc.

It will be appreciated that various changes and modifications can be made to the present invention without departing from the scope of the present application. The blocks illustrated in the FIGS. 5 to 16 may represent steps in a method and/or sections of code in the computer program 110. The illustration of a particular order to the blocks does not necessarily imply that there is a required or preferred order for the blocks and the order and arrangement of the block may be varied. Particularly, where the same effect results despite reordering of certain blocks, those blocks may be reordered. Furthermore, it may be possible for some steps to be omitted.

Features described in the preceding description may be used in combinations other than the combinations explicitly described. Although functions have been described with reference to certain features, those functions may be performable by other features whether described or not. Although features have been described with reference to certain embodiments, those features may also be present in other embodiments whether described or not.

For purposes of this disclosure, it is to be understood that reference to ‘the control system being configured to’ is to be understood to mean ‘the one or more controllers of the control system are collectively configured to’. The controller(s) described herein can each comprise a control unit or computational device having one or more electronic processors, the one or more processors collectively configured to perform the control system functionality set out in the control system claims.

Further aspects of the present invention are laid out in the following numbered clauses:

1. A control system (100) for an automatic transmission (12) of a vehicle (1), the control system (100) comprising one or more processors collectively configured to:
receive (302) a speed parameter signal indicative of a speed parameter;
receive (304) an accelerator input signal indicative of an accelerator input;
receive (348) a powertrain torque signal indicative of an instantaneous powertrain torque;
receive (324) a current gear ratio signal indicative of a current gear ratio;
receive a shift inhibit condition signal indicative of a shift inhibit condition being satisfied;
determine (306) a target gear ratio in dependence on the received speed parameter signal and the received accelerator input signal;
determine (346) if an instantaneously initiated shift will complete during lash crossing in dependence on the powertrain torque signal, the accelerator input signal, and the current gear ratio signal;
inhibit (338) output of a shift initiation signal, the shift initiation signal comprising instructions to cause initiation of a shift to the target gear ratio, for an initial period of time in dependence on the received shift inhibit signal; and
inhibit (344) output of the shift initiation signal, after the initial period of time has elapsed, until it is determined that the instantaneously initiated shift will not complete during lash crossing.

2. A control system (100) for an automatic transmission (12) of a vehicle (1), the control system (100) comprising one or more processors collectively configured to:
receive (302) a speed parameter signal indicative of a speed parameter;
receive (304) an accelerator input signal indicative of an accelerator input;
receive (348) a powertrain torque signal indicative of an instantaneous powertrain torque;
receive (324) a current gear ratio signal indicative of a current gear ratio;
receive a shift inhibit condition signal indicative of a shift inhibit condition being satisfied;
determine (306) a target gear ratio in dependence on the received speed parameter signal and the received accelerator input signal;
determine (346) if an instantaneously initiated shift will complete during lash crossing in dependence on the powertrain torque signal, the accelerator input signal, and the current gear ratio signal;
inhibit (338) output of a shift initiation signal, the shift initiation signal comprising instructions to cause initiation of a shift to the target gear ratio, for an initial period of time in dependence on the received shift inhibit signal; and
output the shift initiation signal, after the initial period of time has elapsed, when it is determined that the instantaneously initiated shift will not complete during lash crossing.

3. The control system (100) of clause 1 or clause 2, wherein determining (346) if an instantaneously initiated shift will complete during lash crossing comprises:
determining from a look-up table (350) a predetermined range of powertrain torque values in dependence on the accelerator input signal and the current gear ratio signal,
wherein the predetermined range of powertrain torque values comprise powertrain torque values which, provided a powertrain torque decline follows a trajectory determined in dependence on the accelerator input signal and the current gear ratio signal, will fall within a lash region of powertrain torque during a duration of a shift; and
comparing (354) the powertrain torque signal to the predetermined range of powertrain torque values, wherein if the instantaneous powertrain torque value indicated by the powertrain torque signal is within the predetermined range of powertrain torque values, the instantaneously initiated shift will complete during lash crossing.

4. The control system (100) of any preceding clause, wherein there is a maximum duration of inhibiting output of the shift initiation signal.

5. The control system (100) of any preceding clause, wherein the shift inhibit condition being satisfied comprises at least one of:
a rate of decrease in the accelerator input exceeding a threshold rate;
a propulsion system of the vehicle being in transition between predefined operating modes;
a different target gear ratio being determined based on a change to at least one of: the speed parameter, the accelerator input, or an active shift map;
a rate of decrease in a powertrain torque exceeding another threshold rate.

6. The control system (100) of clause 5, wherein the initial period of time is determined in dependence on which of the shift inhibit conditions have been satisfied.

7. The control system (100) of any preceding clause, wherein the speed parameter is a speed parameter of the vehicle or of a powertrain component.

8. The control system (100) of any preceding clause, wherein the speed parameter is one or more of the following: a vehicle speed, a wheel speed, a transmission output shaft speed, a transmission input shaft speed, or an engine and/or an electric machine speed.

9. An automatic transmission system (10) comprising the control system (100) of any preceding clause and an automatic transmission (12).

10. A vehicle (1) comprising the automatic transmission system (10) of clause 9.

11. A method (300′) of controlling an automatic transmission (12) of a vehicle (1), the method (300) comprising:
receiving (302) a speed parameter signal indicative of a speed parameter;
receiving (304) an accelerator input signal indicative of an accelerator input;
receiving (348) a powertrain torque signal indicative of an instantaneous powertrain torque;
receiving (324) a current gear ratio signal indicative of a current gear ratio;
receiving a shift inhibit condition signal indicative of a shift inhibit condition being satisfied;
determining (306) a target gear ratio in dependence on the received speed parameter signal and the received accelerator input signal;
determining (346) if an instantaneously initiated shift will complete during lash crossing in dependence on the powertrain torque signal, the accelerator input signal, and the current gear ratio signal;
inhibiting (338) output of a shift initiation signal, the shift initiation signal comprising instructions to cause initiation of a shift to the target gear ratio, for an initial period of time in dependence on the received shift inhibit signal; and
inhibiting (344) output of the shift initiation signal, after the initial period of time has elapsed, until it is determined that the instantaneously initiated shift will not complete during lash crossing.

12. Computer readable instructions which, when executed by a computer, are arranged to perform a method (300) according to clause 11.

1. A control system for an automatic transmission of a vehicle, the control system comprising one or more controllers, the control system configured to:
receive a signal indicative of a speed parameter;
receive a signal indicative of an accelerator input;
determine a target gear ratio based on the speed parameter and the accelerator input;
inhibit output of a signal comprising instructions to cause initiation of a shift to the target gear ratio for an initial period of time in dependence on a shift inhibit condition being satisfied;
after the initial period of time, inhibit output of a signal comprising instructions to cause initiation of a shift to the target gear ratio until it is determined that an instantaneously initiated shift will not complete during lash crossing.

2. The control system of claim 1, wherein the control system is configured to:
receive a signal indicative of a powertrain torque;
receive a signal indicative of a current gear ratio; and
determine if an instantaneously initiated shift will complete during lash crossing in dependence on an instantaneous value of the powertrain torque, the accelerator input, and the current gear ratio.

3. The control system of claim 2, wherein determining if an instantaneously initiated shift will complete during lash crossing comprises:
looking-up, using the accelerator input and the current gear ratio, a predetermined range of powertrain torque values, wherein the predetermined range of powertrain torque values comprise values which, provided a powertrain torque decline follows a trajectory expected at the accelerator input and the current gear ratio, will decline to values within a lash region over a duration of a shift; and
determining if the instantaneous value of the powertrain torque is within the predetermined range of powertrain torque values.

4. The control system of claim 1, wherein there is a maximum duration of inhibiting output of a signal comprising instructions to cause initiation of a shift to the target gear ratio.

5. The control system of claim 1, wherein the shift inhibit condition comprises at least one of the following:
a rate of decrease in the accelerator input exceeding a threshold rate;
a propulsion system of the vehicle being in transition between predefined operating modes;
a different target gear ratio being determined based on a change to at least one of: the speed parameter, the accelerator input, or an active shift map;
a rate of decrease in a powertrain torque exceeding another threshold rate.

6. The control system of claim 1, wherein the initial period of time is based on the shift inhibit condition which has been satisfied.

7. The control system of claim 1, wherein the speed parameter is a speed parameter of the vehicle or of a powertrain component.

8. The control system of claim 1, wherein the speed parameter is one of the following: a vehicle speed, a wheel speed, a transmission output shaft speed, a transmission input shaft speed, or an engine and/or electric machine speed.

9. An automatic transmission system comprising the control system of claim 1 and an automatic transmission.

10. A vehicle comprising the automatic transmission system of claim 9.

11. A method of controlling an automatic transmission of a vehicle, the method comprising:
receiving a signal indicative of a speed parameter;
receiving a signal indicative of an accelerator input;
determining a target gear ratio based on the speed parameter and the accelerator input;
inhibiting output of a signal comprising instructions to cause initiation of a shift to the target gear ratio for an initial period of time in dependence on a shift inhibit condition being satisfied;
after the initial period of time, inhibiting output of a signal comprising instructions to cause initiation of a shift to the target gear ratio until it is determined that an instantaneously initiated shift will not complete during lash crossing.

12. Computer readable instructions which, when executed by a computer, are arranged to perform a method according to claim 11.
